(19) United States
(12) Patent Application Publication
(10) Pub. No.: US 2026/0015210 A1
(43) Pub. Date: Jan. 15, 2026

(54) Portable Power-Assisted Winch Device

(71) Applicant: Michael Caples, Clinton, IA (US)

(72) Inventor: Michael Caples, Clinton, IA (US)

(21) Appl. No.: 19/263,902

(22) Filed: Jul. 9, 2025

Related U.S. Application Data
(60) Provisional application No. 63/669,718, filed on Jul. 11, 2024.

(51) Int. Cl. B66D 1/12; B66D 1/04

(52) U.S. Cl. CPC B66D 1/12; B66D 1/04

(57) ABSTRACT

The present invention is a speed or power assisted winch device designed to assist in lifting and pulling heavy objects using the mechanical power of a winch combined with an impact drill. The speed or power assisted winch device includes a portable winch body with a rotating drum for winding a chain or rope, a lever, and a ½-inch impact drill connection drive that is compatible with an impact drill bit. The impact drill when attached to the ½-inch impact drill connection drive, transfers torque to rotate the winch drum, enabling hands-free lifting or lowering of loads. Additionally, the device includes an auto-lock mechanism that secures the load at a predetermined height. The invention reduces the physical effort required to lift heavy loads, enhances safety, and is adaptable for various applications, including construction, maintenance, and recreational lifting tasks.

### CROSS-REFERENCE TO RELATED APPLICATION

The present application claims priority to, and the benefit of, U.S. Provisional Application No. 63/669,718 which was filed on Jul. 11, 2024 and is incorporated herein by reference in its entirety.

### FIELD OF THE INVENTION

The present invention generally relates to lifting devices. More specifically, the invention relates to a power-assisted speed or power assisted winch device designed to facilitate the lifting and pulling of heavy loads by combining a winch mechanism with an impact drill attachment. The winch device includes a compact, portable body with a rotating drum that winds a chain or rope to lift or move loads efficiently. The device features a ½-inch drive connection, enabling the device to connect with a standard impact drill, thus transferring the torque from the impact drill to the winch drum for automating the lifting process. Accordingly, the present disclosure makes specific reference thereto. Nonetheless, it is to be appreciated that aspects of the present invention are also equally applicable to other like applications, devices, and methods of manufacture.

### BACKGROUND

By way of background, lifting heavy objects manually is a common requirement in various industries, including construction, manufacturing, maintenance, and logistics. However, manual lifting can be physically exhausting and may lead to discomfort or even chronic pain in the arms, hands, and back. The physical strains due to heavy lifting significantly affect workers' health and productivity over time. Additionally, manual lifting is inefficient as it leads to frequent breaks and slower work progress.

Commonly, a manual chain winch is used to lift, lower, or pull heavy loads by manually operating a lever or pulling a chain. Manual chain winches are used at construction sites, automotive repairs, warehouses, industries, and more. However, manual chain winches are also ineffective and cause physical strains. In environments where productivity and efficiency are critical, such as in high-demand production or construction settings, the limitations of manual lifting create bottlenecks that hinder work timelines and increase labor costs. Individuals desire a device that can assist in lifting heavy objects efficiently, reducing physical strain on workers, and minimizing downtime.

Therefore, there exists a long-felt need in the art for a lifting device that minimizes physical strain and fatigue on workers while improving productivity and efficiency in lifting heavy objects. There is a long-felt need for a device that enables individuals to lift or pull heavy loads without relying on extensive physical exertion, reducing the risk of injury. Additionally, there is a long-felt need for a lifting tool that integrates seamlessly with common power tools, such as impact drills, to enhance case of use and portability. Moreover, there is a long-felt need for a winch that includes safety mechanisms to protect users and prevent accidental drops. Further, there is a long-felt need for a winch that is lightweight, durable, and designed for repeated use in various environments, from construction sites to vehicle maintenance settings. Finally, there is a long-felt need in the art for a load lifting winch that saves time and effort when working on job sites that require individuals to lift heavy objects.

The subject matter disclosed and claimed herein, in one embodiment, comprises a speed or power assisted winch device specifically designed to address the limitations of conventional lifting devices and winches. The device includes a compact winch body with a rotating drum that winds and unwinds a chain or rope, enabling the lifting and pulling of heavy loads. The winch is equipped with, for example, a ½-inch drive connection that is compatible with standard impact drills. The ½-inch drive (or other sizes of drives) enables users to power the winch using the impact drill instead of manual effort. The impact drill connection drive transfers high torque from the drill to the winch drum, automating the winding process and eliminating the need for physical strength. It is to be appreciated that other sized drills can be used, for example, ¾-inch drive.

In this manner, the device of the present invention accomplishes all of the foregoing objectives and provides a powerful, efficient solution for lifting and pulling heavy loads. The winch device is compatible with impact drills which enables users to operate the winch effortlessly, even in remote or challenging locations. The torque from the impact drill is used for rotating the drum of the winch device for lifting a load. The device withstands repeated and intensive use, making it a cost-effective alternative to traditional winches that require manual operation. The device keeps the arms and hands fresh to prevent fatigue while working with heavy equipment. Further, the device saves time and effort when working on job sites that require individuals to lift heavy objects.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a speed or power assisted winch device for lifting heavy objects. The device comprises a winch body configured for portable use, the winch body includes a rotating drum configured to wind and unwind a chain or rope for lifting or pulling a load. A lever is operatively connected to the rotating drum for manual operation. An impact drill connection drive is operatively connected to the rotating drum, wherein the impact drill connection drive is a ½-inch drive and is connected to an impact drill such that torque generated by the impact drill rotates the drum, thereby winding or unwinding the chain or rope around the drum to lift or lower the load. The impact drill connection drive is constructed from impact-rated materials selected from the group consisting of chrome vanadium steel and chrome molybdenum steel and includes a protective coating to prevent rust and corrosion.

In another aspect, a load lifting system is disclosed. The load lifting system includes a speed or power assisted winch device which includes a winch body with a rotating drum, a lever is attached to the winch body, and an impact drill connection drive is operatively connected to the winch drum, the impact drill connection drive is configured with a, for example, ½-inch square fitting for attachment to an impact drill bit of an impact drill. The impact drill is operable to transmit torque through the impact drill connection drive to rotate the winch drum, thereby winding or unwinding a chain or rope attached to a load. A control module is integrated with the winch body, the control module is configured to regulate the speed of the winch drum rotation and to activate an auto-lock mechanism when the load reaches a predetermined height.

In another embodiment, a method for lifting a load using a speed or power assisted winch device and an impact drill is disclosed. The method includes the steps of attaching the impact drill to an impact drill connection drive on the speed or power assisted winch device, the impact drill connection drive being operatively connected to a winch drum within the speed or power assisted winch device, activating the impact drill to generate torque, the torque being transferred through the impact drill connection drive to rotate the winch drum, and winding a chain or rope around the winch drum to lift the load.

In yet another aspect, the method includes automatically engaging an auto-lock mechanism within the winch drum when the load reaches a predetermined height to secure the load in place.

In one embodiment, the control module adjusts height setting that enables a user to preselect a desired height at which the winch drum automatically locks, providing customizable control over the lifting operation.

In another aspect, the winch body further includes an integrated gearbox connected to the rotating drum, the gearbox is configured to adjust the rotational speed of the drum in response to variations in load weight.

Numerous benefits and advantage of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of portable power-assisted winch device of the present invention in accordance with the disclosed structure;

FIG. 2 illustrates a perspective view showing an impact drill being operatively connected to the ½-inch drive for rotating the winch drum in accordance with the disclosed structure;

FIG. 3 illustrates an enlarged view of coupling between the winch drum and the ½-inch drive for facilitating rotation of the drum in accordance with the disclosed structure; and

FIG. 4 illustrates another perspective view of the impact drill being attached to the winch device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a lifting device that minimizes physical strain and fatigue on workers while improving productivity and efficiency in lifting heavy objects. There is a long-felt need for a device that enables individuals to lift or pull heavy loads without relying on extensive physical exertion, reducing the risk of injury. Additionally, there is a long-felt need for a lifting tool that integrates seamlessly with common power tools, such as impact drills, to enhance case of use and portability. Moreover, there is a long-felt need for a winch that includes safety mechanisms to protect users and prevent accidental drops. Further, there is a long-felt need for a winch that is lightweight, durable, and designed for repeated use in various environments, from construction sites to vehicle maintenance settings. Finally, there is a long-felt need in the art for a load lifting winch that saves time and effort when working on job sites that require individuals to lift heavy objects.

The present invention, in one exemplary embodiment, is a load lifting system. The load lifting system includes a speed or power assisted winch device which includes a winch body with a rotating drum, a lever is attached to the winch body, and an impact drill connection drive is operatively connected to the winch drum, the impact drill connection drive is configured with a, for example, ½-inch square fitting for attachment to an impact drill bit of an impact drill. The impact drill is operable to transmit torque through the impact drill connection drive to rotate the winch drum, thereby winding or unwinding a chain or rope attached to a load. A control module is integrated with the winch body, the control module is configured to regulate the speed of the winch drum rotation and to activate an auto-lock mechanism when the load reaches a predetermined height.

Reference will now be made in detail to the present preferred embodiments of the invention, examples of which are illustrated in the accompanying drawings. Wherever possible, the same reference numerals are used in the drawings and the description to refer to the same or like parts.

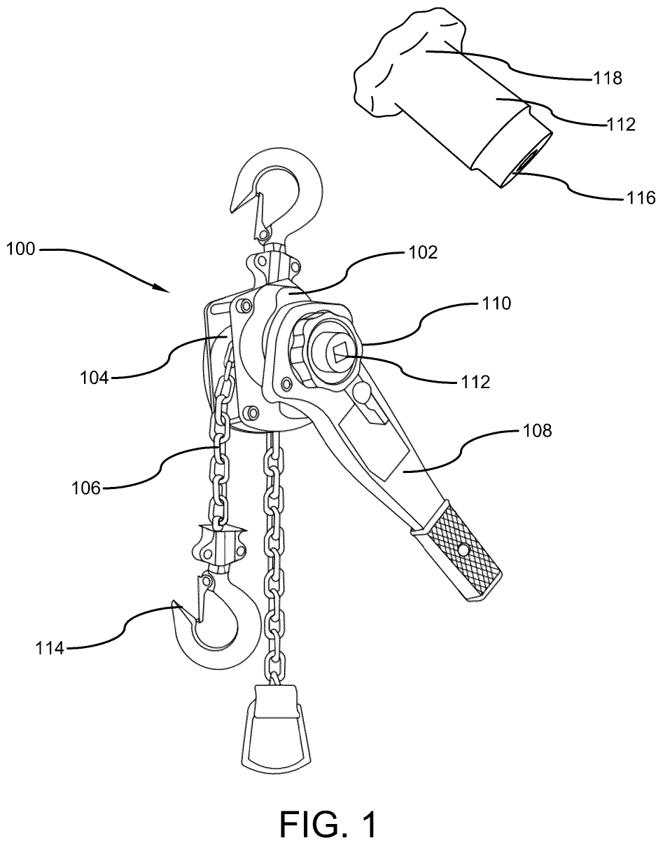

Referring initially to the drawings, FIG. 1 illustrates a perspective view of a portable power-assisted winch device of the present invention in accordance with the disclosed structure. The portable power-assisted winch device 100 of the present invention is designed to assist in lifting heavy objects by using the mechanical power of a winch combined with the impact force from a connected impact drill. More specifically, the impact drill compatible winch device 100 includes a winch 102 which is preferably portable and handheld but can be of any shape and size. The winch 102 includes a rotatable drum or spool 104 wherein a chain or rope 106 is removably rolled or wound onto the spool 104. The winch 102 is like a conventional manual chain winch and includes a lever 108 for manual operation of the winch 102 as required by an operator. The winch 102 can be used to lift or pull heavy objects by winding up the chain 106, which increases mechanical advantage/leverage and makes lifting easier.

An impact drill connection drive 112 is disposed on the top end 110 of the lever 108. Further, the impact drill connection drive 112 is operatively connected to the winch drum 104 and is configured to serve as an attachment means for an impact drill wherein the torque generated by the impact drill rotates the winch drum 104, thereby winding the cable 106 around the drum 104 to lift a load attached to the hook 114. Preferably, the impact drill connection drive 112 is a ½-inch drive and is adapted to be compatible with conventional impact drills.

The drive 112 is adapted to exert between 300 to 1,500 ft-lbs. of torque and is compatible with standard ½-inch square fittings found on impact drills. In the preferred embodiment, the driver 112 is made from one of chrome vanadium steel, chrome molybdenum steel and is coated with a protective layer of black oxide or chrome plating to prevent rust and corrosion. The driver 112 has a length extending between the free end 116 and the fixed end 118 in the range between 1 inch and 4 inches. The impact-rated ½-inch drive 112 is specifically designed to withstand the repeated high-impact torque from impact drills and wrenches.

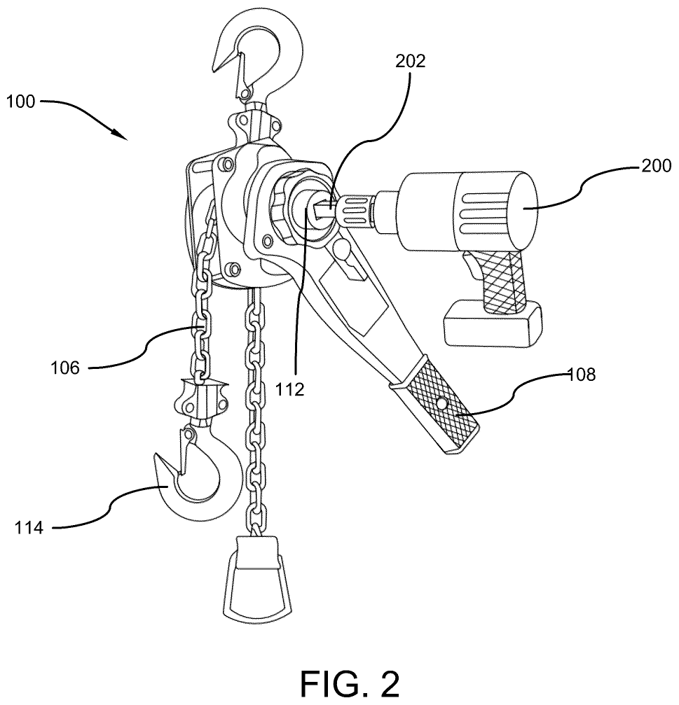

FIG. 2 illustrates a perspective view showing an impact drill being operatively connected to the ½-inch drive for rotating the winch drum in accordance with the disclosed structure. As illustrated, drill bit 202 of an impact drill 200 is removably secured to the impact-rated ½-inch drive 112 such that a user can operate/actuate the impact drill device 200 using one hand while simultaneously holding the winch device 100 in another hand. The operatively connected impact-rated ½-inch drive 112 and the drill bit 202 enables the rotational power of the impact drill 200 to rotate the winch drum 104. Accordingly, the lever 108 which is pushed up and down to operate the winch manually, is bypassed for an easy operation and use of the impact drill compatible winch device 100. High torque of the impact drill 200 enables it to rotate the winch drum 104, thereby winding or unwinding the chain 106 without requiring manual force.

Use of the impact drill 200 with the winch device 100 enables the user to lift or pull heavy loads without having to apply physical effort manually. Further, the user can regulate the torque of the impact drill 200 depending on the design and rotational specification of the winch device 100. The speed or power assisted winch device 100 reduces the physical energy required by an operator while offering a high level of lifting capability.

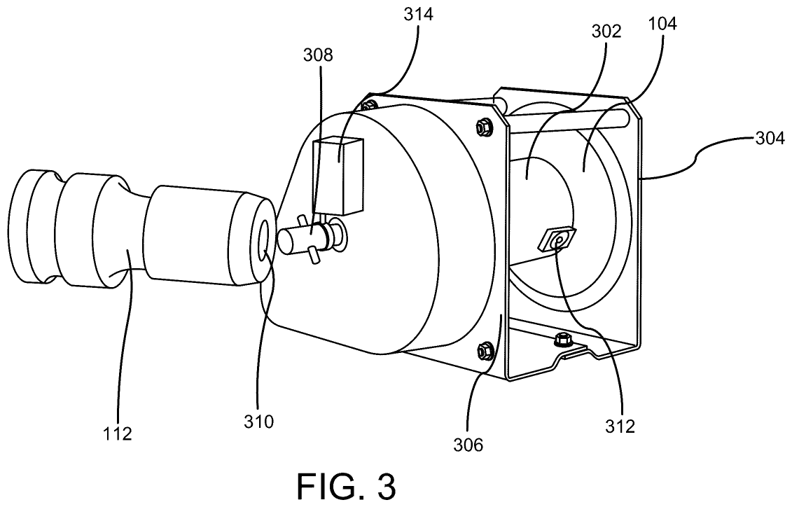

FIG. 3 illustrates an enlarged view of coupling between the winch drum and the ½-inch drive for facilitating rotation of the drum in accordance with the disclosed structure. The winch drum 104 includes a drive hub 302 which extends between the opposite ends 304, 306 of the drum 104 and one end 308 of the drive hub 302 is fastened to one end 310 of the ½-inch drive 112, thereby rotating or actuating the drive hub 302 using the impact drill 200. In some embodiments, the drive 112 and the drive hub 302 are integrated and alternatively, can be removably attached, thereby enabling a user to replace the ½-inch drive 112 as per their preferences.

In one embodiment, the winch drum 104 is adapted to auto-lock using a control module 314 which stops the rotation of the drum 104 when the hook 114 reaches a desired height such become coplanar to the drum 104. The drum 104 also prevents sudden back driving if the impact drill stops unexpectedly or if the load shifts. The winch device 100 may also include an integrated gearbox 312 to control the speed of rotation of the drum 104 for safety and control of the load being lifted using the impact drill 200.

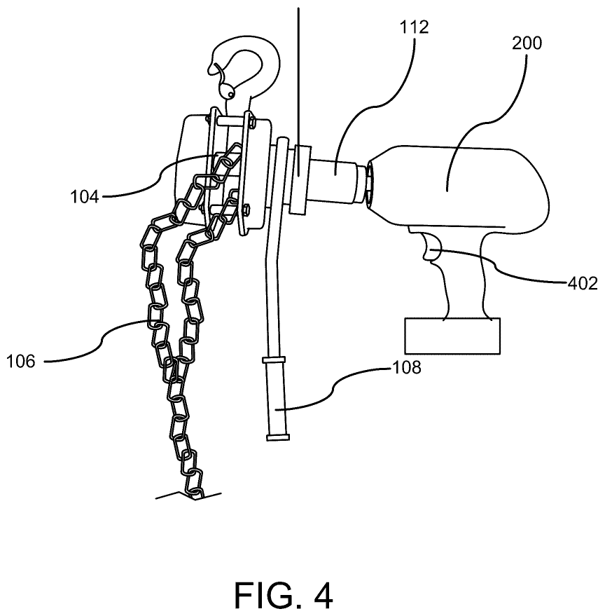

FIG. 4 illustrates another perspective view of the impact drill being attached to the winch device in accordance with the disclosed structure. The trigger 402 of the impact drill 200 is easily accessible when the ½-inch drive 112 is engaged to the drill bit. By using the electric impact drill 200 rather than a fully mechanical or manually operated system, the speed or power assisted winch device 100 reduces the physical energy expenditure required by the user while still offering a high level of lifting capability. The speed or power assisted winch device 100 can be used for a wide range of lifting tasks, including construction work, moving heavy equipment, vehicle repair, and recreational activities like camping where lifting heavy loads may be necessary.

The impact drill assisted winch device 100 can be used for lifting a load using an impact drill. The process of lifting the load includes attaching the impact drill to an impact drill connection drive on the speed or power assisted winch device, wherein the impact drill connection drive is operatively connected to a winch drum within the speed or power assisted winch device. The method further includes activating the impact drill to generate torque, which is then transferred through the impact drill connection drive to rotate the winch drum. This rotation winds a chain or rope around the winch drum, thereby lifting the load. The method also includes automatically engaging an auto-lock mechanism within the winch drum when the load reaches a predetermined height, securing the load in place.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable power-assisted winch device”, “impact drill compatible winch device”, “speed or power assisted winch device”, “winch device”, and “impact drill assisted winch device” are interchangeable and refer to the portable power-assisted winch device 100 of the present invention.

Notwithstanding the forgoing, the portable power-assisted winch device 100 of the present invention can be of any suitable size and configuration as is known in the art without affecting the overall concept of the invention, provided that it accomplishes the above stated objectives. One of ordinary skill in the art will appreciate that the portable power-assisted winch device 100 as shown in the FIGS. are for illustrative purposes only, and that many other sizes and shapes of the portable power-assisted winch device 100 are well within the scope of the present disclosure. Although the dimensions of the portable power-assisted winch device 100 are important design parameters for user convenience, the portable power-assisted winch device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable power-assisted winch device comprising:
a winch having a lever, a rotatable drum, a chain, and a connection drive; and
an impact drill having a drill bit;
wherein said winch selectively manually operable by said lever;
wherein said winch is handheld; and
further wherein upon actuation said impact drill rotates said connection drive and said drill bit which in turn rotates said rotatable drum for winding said chain around said rotatable drum and pulling a heavy object.

2. The portable power-assisted winch device of claim 1, wherein said chain is a rope.

3. The portable power-assisted winch device of claim 1, wherein said connection drive is disposed on a top end of said lever.

4. The portable power-assisted winch device of claim 3, wherein said connection drive is operatively connected to said rotatable drum.

5. The portable power-assisted winch device of claim 4, wherein said connection drive is a ½-inch drive.

6. The portable power-assisted winch device of claim 4, wherein said connection drive is a ¾-inch drive.

7. The portable power-assisted winch device of claim 5, wherein said connection drive having a torque from 300 ft-lbs. to 1,500 ft-lbs.

8. The portable power-assisted winch device of claim 6, wherein said connection drive having a torque from 300 ft-lbs. to 1,500 ft-lbs.

9. The portable power-assisted winch device of claim 7, wherein said connection drive having a length from 1 inch to 4 inches.

10. A portable power-assisted winch device comprising:
a winch having a lever, a rotatable drum, a chain, and a connection drive; and
an impact drill having a drill bit;
wherein said winch selectively manually operable by said lever;
wherein said winch is handheld;
wherein said impact drill and said drill bit removably secured to said connection drive;
wherein upon actuation said impact drill rotates said connection drive and said drill bit which in turn rotates said rotatable drum for winding said chain around said rotatable drum and pulling a heavy object; and
further wherein said impact drill operable with one hand while simultaneously holding said winch with another hand.

11. The portable power-assisted winch device of claim 10, wherein said connection drive is disposed on a top end of said lever.

12. The portable power-assisted winch device of claim 11, wherein said connection drive is operatively connected to said rotatable drum.

13. The portable power-assisted winch device of claim 12, wherein said connection drive is a ½-inch drive.

14. The portable power-assisted winch device of claim 12, wherein said connection drive is a ¾-inch drive.

15. The portable power-assisted winch device of claim 13, wherein said connection drive having a torque from 300 ft-lbs. to 1,500 ft-lbs.

16. The portable power-assisted winch device of claim 14, wherein said connection drive having a torque from 300 ft-lbs. to 1,500 ft-lbs.

17. The portable power-assisted winch device of claim 15, wherein said connection drive having a length from 1 inch to 4 inches.

18. A method of using a portable power-assisted winch device, the method comprising the steps of:
providing a winch having a lever, a rotatable drum, a chain, and a connection drive;
providing an impact drill having a drill bit, wherein said winch selectively manually operable by said lever, and wherein said winch is handheld;
selectively securing said impact drill and said drill bit to said connection drive;
bypassing said lever;
actuating said impact drill to rotate said connection drive and said drill bit which in turn rotates said rotatable drum;
winding said chain around said rotatable drum and pulling a heavy object; and
operating said impact drill with one hand while simultaneously holding said winch with another hand.

19. The method of using a portable power-assisted winch device of claim 18 further comprising a step of controlling a speed of rotation of said rotatable drum with an integrated gearbox.

20. The method of using a portable power-assisted winch device portable of claim 19, wherein said connection drive having a torque from 300 ft-lbs. to 1,500 ft-lbs.
